(19) United States
(12) Patent Application Publication
(10) Pub. No.: US 2012/0109706 A1
(43) Pub. Date: May 3, 2012

(54) IDENTIFYING A CANDIDATE ACTION FOR AN ISSUE

(76) Inventors: MARIANNE HICKEY, Bristol (GB); Hiram Trimble Davis, Austin, TX (US); Maher Rahmouni, Bristol (GB)

(21) Appl. No.: 12/913,870

(22) Filed: Oct. 28, 2010

(51) Int. Cl. G06Q 10/00; G06F 17/30

(52) U.S. Cl. 705/7.23; 707/802; 707/E17.005

(57) ABSTRACT

Information relating to a particular issue associated with a particular project is received. In response to the information, at least one candidate action to take to address the particular issue is identified.

### BACKGROUND

Within an enterprise, such as a company, educational organization, government agency, and so forth, projects are performed as part of the operations of the enterprise. Often, there can be issues relating to a project that may adversely affect performance of the project.

### BRIEF DESCRIPTION OF THE DRAWINGS

Some embodiments are described with respect to the following figures:

FIG. 1 is a flow diagram of a procedure according to some implementations;

FIG. 2 is a block diagram of a diagnosis and action recommendation system according to some implementations;

FIG. 3 is a flow diagram of a process performed by a recommender module, according to some implementations;

FIG. 4 is a timing diagram showing values of a metric associated with an issue, for processing in accordance with some implementations; and

FIG. 5 is a block diagram of an example system incorporating some implementations.

### DETAILED DESCRIPTION

Personnel associated with an enterprise, such as a company, educational organization, government agency, or other organization, can be engaged in performing various projects. A “project” refers to a collection of activities to be performed by an individual or a group of individuals. Examples of projects include a project to provide information technology support, a project related to development of a product or service, a project related to delivery of a product or service, and so forth. As used here, the term “project” can refer to an individual project, or alternatively, to a portfolio of projects.

During the lifecycle of a project, alerts (e.g., warnings, alarms, or other status indications) may be raised to provide an indication to a decision maker regarding a potential issue, where this potential issue may adversely affect the success of the project. A decision maker has to decide how to react to the issue, by assessing the cause and choosing the most appropriate course of action to address the issue. Typically, a decision maker relies upon the decision maker's experience and other knowledge to manually select the action(s) to take. However, such manual selection of action(s) is time-consuming and may result in an action that does not effectively address the issue. As a result, the project may fail, or the project may not meet customer expectations.

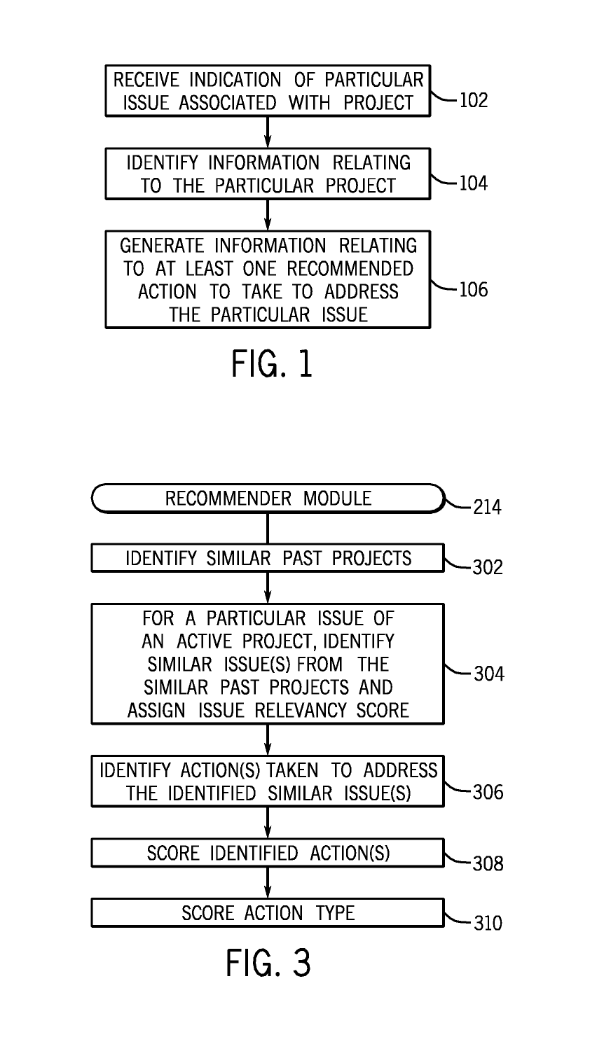

In accordance with some embodiments, techniques or mechanisms are provided to allow for automated generation of recommended action(s) to take for addressing a particular issue faced by a particular project (e.g., an active project that is currently under consideration). FIG. 1 is a flow diagram of a process according to some implementations. The process of FIG. 1 includes receiving (at 102) an indication of the particular issue associated with the particular project. In response to the indication, the process of FIG. 1 identifies (at 104) information relating to the particular issue. The information relating to the particular issue can include the following information: the metric(s) associated with the particular issue (where a metric can include cost, time, quality, or some other metric); and/or details regarding the issue, including information regarding how each metric violates predefined criterion(ia).

In some examples, the indication that is received (at 102) can be based on a predefined rule, which can describe a condition relating to a status indication for the particular project. For example, the rule can be as follows:

If (ProjectStageCost>ProjectStageCostThreshold) Then SignalRed, where SignalRed represents a status indication (for indicating an alarm), ProjectStageCost is a metric that represents a given stage of the particular project, and ProjectStageCostThreshold is a predefined threshold. In response to the status indication Signal Red, the process of FIG. 1 can identify (at 104) information relating to the particular issue by determining which metric (ProjectStageCost) contributed to the status indication, and the criterion (ProjectStageCost>ProjectStageCostThreshold) violated by the metric that resulted in the receipt of the indication (at 102).

Although a specific example is provided above, it is noted that other implementations can employ other types of status indications and other metrics. Note also that a metric can be a raw project measurement (e.g., actual cost), or the metric can be a derivative of a raw project measurement (e.g., probability of actual cost exceeding a threshold).

There can also be multiple rules involved in generation of a status indication, where these multiple rules can be chained. In the context of chained rules, the identification (at 104) of information relating to the particular issue can involve backtracking through the rules of the chain to determine a root cause. Moreover, there can be more than one trigger for any particular status indication, where the more than one trigger can involve multiple metrics violating multiple predefined criteria, for example.

In response to the identifying of the information (at 104), the process of FIG. 1 generates (at 106) information relating to at least one recommended action to take to address the particular issue. The at least one recommended action is identified based on information of selected past projects. The selected past projects can be past projects that are similar to the active project that is currently under consideration. The at least one recommended action can then be performed (either automatically by a system or manually by personnel associated with the project) to resolve the particular issue in the active project.

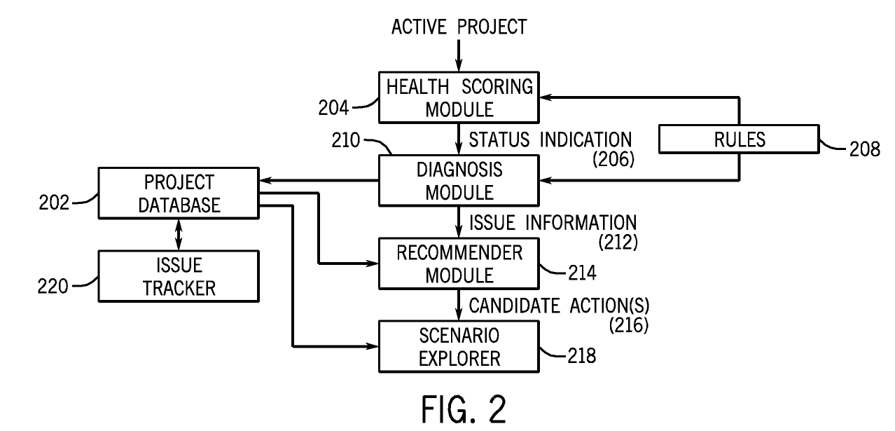

FIG. 2 is a block diagram of various components of a system according to some implementations. The system of FIG. 2 depicts a project database 202 that stores information relating to various projects, including past projects as well as a current (active) project. FIG. 2 also shows a health scoring module 204 that is used for generating a status indication (206), such as the status indication received at 102 in FIG. 1. The generation of the status indication (206) can be based on one or multiple rules 208. As noted above, each rule (208) can describe a condition that controls generation of a status indication for a particular project. In some implementations, the condition is based on a probability of an issue occurring.

The condition described by the rule can be represented as an expression, where the expression can specify one or multiple metrics associated with the project and a relationship of the one or multiple metrics with respect to one or multiple criteria. The expression can include a logical operator, a conditional operator, or some other type of operator. The operator acts on one or multiple metrics associated with the project. Example project metrics include cost, time, resource, quality, and so forth.

The rule describing the condition that is based on a probability of an issue occurring can be specified by a user, such as a project manager. The rule can be manually or automatically created or adjusted, or alternatively, the rule can be a default rule provided for a particular project type, organization, industry sector, and so forth. As examples, the condition can be based on a probability of a project metric (cost, time, resource, quality, etc.) being a certain value or within a certain range (e.g., between two thresholds, below a threshold, or above a threshold).

Once a condition is satisfied, then a status indication can be produced. The status indication can be set to one of plural states. Based on the condition being satisfied, the status indication is selectively set to one of plural states. Where the condition is deterministic, the plural states may include, for example, a first state indicating that a project is healthy, a second state providing an actual warning (indicating, for example, that an issue has reached a state that is adversely affecting the project) and one or more intermediate states to provide an early warning (to indicate, for example, that an issue that can adversely affect the project has or is about to occur). Where the condition is probabilistic, the plural states may include, for example, a first state indicating that a project's future health state is predicted to be good, a second state providing an early warning (indicating that the project's future health state is likely to be bad, for example, an issue is likely to adversely affect the project) and one or more intermediate states to provide an early warning (to indicate that the project's health state is likely to move to a questionable state, e.g. an issue that can adversely affect the project has a worrying likelihood of occurring). Additionally, a further action can be taken in response to the condition being satisfied.

In some implementations, the generation of the status indication (206) can be accorded to techniques or mechanisms described in U.S. patent application entitled “Providing a Status Indication for a Project,” (having Attorney Docket No. 201000488-1), filed of even date herewith. In other implementations, other techniques of producing the status indication 206 based on a rule (or multiple rules) can be employed.

The status indication (206) produced by the health scoring module 204 is provided to a diagnosis module 210. In some implementations, the diagnosis module 210 is configured to perform tasks 102 and 104 depicted in FIG. 1. As noted above, task 104 in FIG. 1 identifies information relating to a particular issue, in response to receipt (102) of a status indication regarding the particular issue. In some examples, the information relating to the particular issue can include the following information: the metric(s) associated with the particular issue (where a metric can include cost, time, quality, or some other metric); and/or details regarding the issue, including information regarding how each metric violates predefined criterion(ia).

Once the information relating to a particular issue (associated with the status information 206) is identified by the diagnosis module 210, the diagnosis module 210 passes such issue information (212) to a recommender module 214. The diagnosis module 210 can also provide the issue information 212 to the project database 202 to update the project database 202.

The recommender module 214 performs the generating task 106 of FIG. 1, as discussed above. As depicted in FIG. 2, the recommender module 214 receives input from the project database 202, where the received input includes information associated with selected past projects, such as past projects that are similar to the active project according to some predefined criterion. The candidate action(s) generated by the recommender module 214 can be based on information relating to actions taken to address the same or similar issue in the selected past projects.

Generally, the recommended module 214 is able to assign scores to respective candidate actions generated by the recommender module 214 for addressing a particular issue. The scores can be assigned based on analyzing data from past projects. Alternatively, the scores can be predefined estimated scores associated with particular types of actions.

In implementations in which the recommender module 214 analyzes data from selected past projects to generate candidate action(s), the recommender module 214 finds issue(s) in the selected past projects that are relevant to the particular issue of the active project. For each such issue in the selected past projects found by the recommender module 214, the recommender module 214 also retrieves information regarding actions that were taken to resolve such identified issue(s) in the selected past projects.

The actions relating to the identified issue(s) in the past projects can be scored based on one or some combination of the following: (1) respective impacts of the actions on the identified issue(s) in the selected past projects; (2) relative relevancy of the identified issue(s) in the selected past projects to the particular issue of the active project; and (3) relative relevancy of respective ones of the selected past projects to the active project.

Based on the scores for the actions taken with respect to the identified issue(s) in the past projects, the scores for the candidate actions generated for the active project can be calculated. For example, the candidate actions for the active project produce by recommender module 214 can be the actions taken to resolve the identified issue(s) in the selected past projects. In such example, the scores of the candidate actions are the scores assigned to the corresponding actions of the selected past projects.

In some implementations, a score can also be calculated for each action type based on aggregating the scores of selected ones of the actions of the given type taken in the selected past projects. An action type can be, for example, a type of action relating to increasing resources, a type of action relating to reducing scope, a type of action relating to decreasing costs, and so forth.

In the discussion above, the recommender module 214 analyzes information from selected past projects (e.g., similar past projects) to generate candidate action(s) 216. In other implementations, the recommender module 214 does not look at information associated with past projects. Instead, predefined (or default) candidate action(s) can be associated with each type of issue. Thus, based on issue information (212) associated with a particular issue (which is of a given type), the respective predefined (or default) candidate action is output by the recommender module 214.

Alternatively, candidate actions can include selection or deselection of sub-components of a project. If the project refers to a portfolio of projects, then the sub-components can be the projects within the portfolio. If the project refers to an individual project, the sub-components refer to different stages of the individual project. The effectiveness of an action (selection or deselection of a sub-component) can be determined by ascertaining the effect of adding or removing the sub-component on the particular issue. Once the sub-component is added or removed, the health scoring module 204 can be re-run to determine whether a status indication (206) would be generated. In this manner, the particular action (adding or removing of a sub-component) can be scored, and the corresponding score can be presented to a user to allow the user to make a decision on whether or not to perform the particular action (adding or removing a sub-component).

As further depicted in FIG. 2, the candidate action(s) produced by the recommender module 214 is output (at 216) to a scenario explorer 218. The scenario explorer 218 is able to present, for viewing, identified candidate action(s) in a user interface, such as a graphical user interface (GUI). In the user interface, a user can select or deselect corresponding ones of any presented candidate actions.

FIG. 2 also depicts an issue tracker 220 that is responsible for keeping track of issues associated with an active project. The issue tracker 220 captures information regarding issues and actions taken to address issues of the active project (where the actions can include actions generated by the recommender module 214). The issue tracker 220 can output data to update the project database 202. Where appropriate, the issue tracker 220 can ask for user feedback for confirmation to ensure that the issue data is accurate.

The information that can be recorded for an issue can include some combination of the following: an identifier of the issue; a metric that the issue relates to (e.g., cost, resource, time, quality, geographical spread, etc.); the problem with the metric (e.g., too high, too low, out of range, >5% above target, etc.); actions taken to attempt to resolve the issue; outcome of the issue (whether the issue was successfully resolved or not, or a finer grade indication of the degree of success); and/or other details associated with the issue.

By updating the project database 202 with the output of the issue tracker 220, the updated information in the project database 202 can be used by the recommender module 214 to produce candidate action(s) for another issue of the active project indicated by the health scoring module 204.

FIG. 3 shows a process performed by the recommender module 214 according to some implementations. The recommender module 214 identifies (at 302) past projects that are similar to an active project according to some similarity criterion or criteria. In some examples, the identification of similar projects can use similarity mechanisms as described in PCT Appl. No. PCT/US10/30518, entitled “Method and System for Comparing and Locating Projects,” filed Apr. 9, 2010, for finding similar projects.

The project similarity techniques of PCT/US10/30518 extract features of projects being compared, where the features can be extracted from project profiles. The features for the projects are provided to corresponding feature comparators, which output respective feature-similarity values. The outputs from feature comparators are weighted and aggregated by a feature-similarity aggregator(s) to produce a final project-similarity value, which is used to provide a measure of the relative similarity of the compared projects. Further details regarding such project similarity mechanisms are described in PCT/US10/30518. In other implementations, other techniques for finding similar projects can be used.

In task 302, the recommender module 214 can present the identified similar past projects to a user (such as through a user interface) for user feedback regarding whether or not the identified similar past projects are actually similar. Obtaining user feedback to confirm identified similar past projects can improve accuracy of the diagnosis performed by the recommender module 214. Each past similar project can be associated with a score (p). The score for each identified similar past project can be based on an aggregation of a project similarity score and other factors, such as a recency score (to favor projects that occurred more recently in time with respect to the active project).

Next, as depicted in FIG. 3, for a particular issue of the active project, the recommender module 214 identifies (at 304) similar issue(s) from the similar past projects, and assigns issue relevancy score(s) to the identified similar issue(s). In some examples, the identified similar issue(s) from the similar past projects can be issue(s) associated with the same metric and condition (e.g., violation of a predefined criterion) as the particular issue of the active project. In other examples, issue matching techniques can be employed to identify similar issue(s), where such issue matching techniques can compare details associated with the particular issue of the active project with details of issues in the similar past projects. The details that can be compared include details regarding timing of respective projects, metric values, contextual details, and so forth.

The recommender module 214 can also identify (at 306) action(s) taken to address the identified similar issue(s) in the identified past projects. The action impact for each identified action can be determined from the information associated with the similar past projects.

The identified action(s) can also be scored (at 308) by the recommender module 214. The score can be based on a combination of various factors. For example, the score can be a weighted and normalized combination of a project relevancy score (p), issue relevancy score (q), and action impact score (r), where the project relevancy score (p) indicates a degree of relevancy of an identified past project to the active project, the issue relevancy score (q) indicates a degree of relevancy of an identified issue (from a past project) to the particular issue of the active project, and the action impact score (r) indicates the impact (positive or negative) of the action with respect to the respective identified similar issue (from a past project).

The score relating to the impact of an action can be manually entered (for example, a project manager can be prompted to rate the action taken or the project manager can be responsible for entering the score a predefined period after the action was taken). Alternatively, the score of the impact of the action can be automatically determined (for example, if the issue has not been resolved, then the score is zero; otherwise, set the score to one). Alternatively, the score can be automatically based on determining a finer degree of impact by examining how the metric value changed after the action. For example, the rate of change of the metric can be considered at the time of the action, compared to the rate of change of the metric after the action.

As further depicted in FIG. 3, in some implementations, an action type can also be scored (at 310) by the recommender module 214, by aggregating scores for the actions of each type.

The process of FIG. 3 can be repeated for other issues of the active project under consideration (assuming that there are multiple issues indicated by the status indication 206 in FIG. 2). In the scenario where there are multiple issues associated with the active project (and a given action is intended to address the multiple issues), an overall score can be produced for the given action by aggregating scores of the given action for the multiple issues. For example, for the given action, multiple weights can be assigned to the respective multiple issues—the multiple weights can be aggregated to produce an overall score for the given action.

As noted above, the scenario explorer module 218 is able to present candidate actions in a user interface to allow for user selection and/or deselection of the respective ones of the candidate actions. The candidate actions can be presented in the user interface using any one or a combination of the following: the candidate actions can be listed in order of respective scores of the actions; the candidate actions can be grouped in categories corresponding to action types, where the categories are ordered according to the action type scores; the candidate actions relevant to different metrics are provided in respective different groups; candidate actions or action types are having scores below a particular threshold are filtered out; and others.

The scenario explorer module 218 is able to present further information regarding a candidate action, such as more detailed scores or information on how the candidate action may contribute to the metric. The scenario explorer module 218 can represent scores by numbers, colors, graphics, and so forth.

In addition to being able to select or deselect candidate actions, the user interface presented by the scenario explorer module 218 also allows a user to edit a given candidate action. The scenario explorer module 218 can also provide a view of results of actions from information relating to the identified similar past projects, for example.

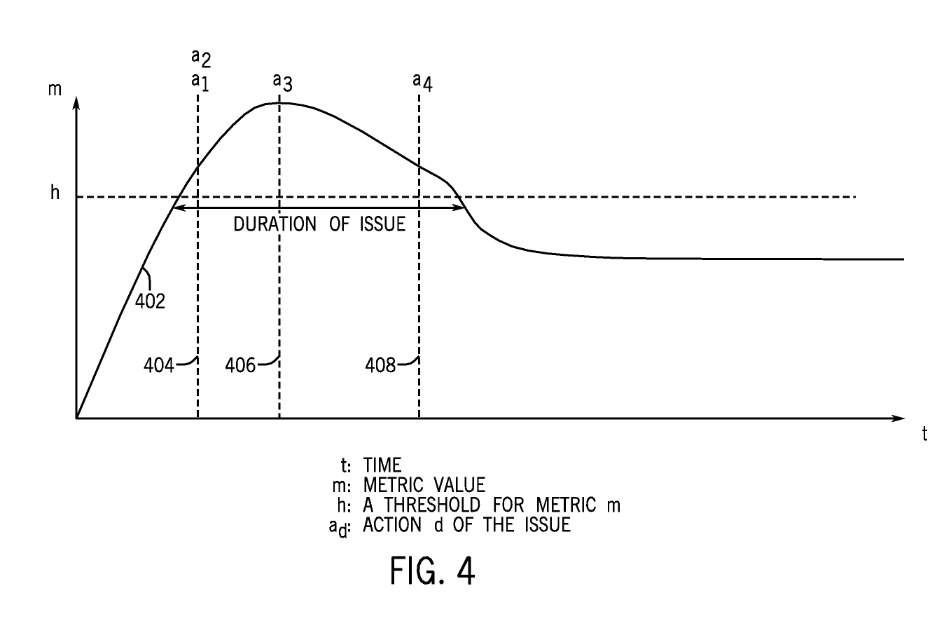

FIG. 4 illustrates a timing diagram that illustrates values of a metric over time, where the metric is represented as m. A horizontal-line (h) represents a threshold for the metric m. In FIG. 4, an issue starts when the value of the metric m crosses the threshold h. In the example of FIG. 4, actions a₁ and ₂ are performed at time 404. Also, action a₃ is performed at time 406, and action a₄ is performed at time 408. The duration of the issue extends from the point where the curve 402 crosses the threshold h, to the point where the curve 402 drops below the threshold h.

The graph of FIG. 4 can be presented by the scenario explorer module 218 to illustrate effectiveness of actions taken with respect to an issue.

Each action taken may affect more than one issue (e.g., increasing resources may affect issues concerning time and cost metrics). An action a_{d} can be associated with the following information: identifier of the action; a type of action (e.g., increase resources, change suppliers, change scope, etc.) (note that there can be a null action type, which is used to represent that no action was taken to address an issue); timing to indicate when the action took place relative to the start of the issue, or more detailed information such as start and end time points; an indication of an impact of the action on the metric associated with the issue; and/or other details regarding the action.

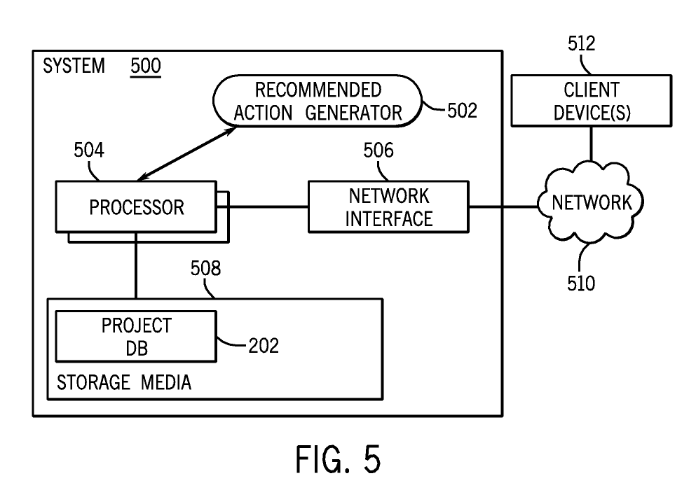

FIG. 5 depicts an example system 500, which can be implemented as a single computer node or multiple computer nodes in a distributed environment. The system 500 includes a recommended action generator 502, which can be implemented with the components of FIG. 2, for example.

The recommended action generator 502 can be implemented as machine-readable instructions executable on a processor (or multiple processors) 504. The processor(s) 504 is (are) connected to a storage media 508, which stores the project database 202. The system 500 also includes a network interface 506 to allow the system 500 to communicate over a network 510 with client device(s) 512, such as to report recommended actions according to some implementations.

The processor 504 can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system having a processor, an indication of a particular issue associated with a particular project;
identifying, by the system in response to the indication, information relating to the particular issue; and
generating, by the system in response to the identifying, information relating to at least one candidate action to take to address the particular issue, wherein the at least one candidate action is identified based on information of selected past projects.

2. The method of claim 1, wherein the at least one candidate action is identified based on information relating to actions taken to address an identified at least one issue of the selected past projects.

3. The method of claim 2, further comprising:
determining the identified at least one candidate action based on determining relevancy of the identified at least one issue to the particular issue.

4. The method of claim 2, further comprising:
assigning scores to the actions taken in the selected past projects, wherein the scores are assigned according to one or a combination of: (1) respective impacts of the actions on the at least one issue, (2) relative relevancy of the at least one issue to the particular issue, and (3) relative relevancy of respective ones of the selected past projects to the particular project.

5. The method of claim 4, further comprising assigning a score to a given type of action based on aggregating the scores of selected ones of the actions of the given type taken in the selected past projects.

6. The method of claim 1, wherein the identified information relating to the particular issue comprises a metric that is related to the particular issue.

7. The method of claim 6, wherein the identified information relating to the particular issue comprises a condition violated by the metric.

8. The method of claim 1, further comprising:
capturing, using an issue tracker, information relating to the particular issue and the at least one candidate action performed to address the particular issue.

9. The method of claim 8, wherein the captured information is part of a collection of information maintained by the issue tracker for respective issues associated with projects, the method further comprising:
receiving information relating to a second issue;
accessing the collection to obtain information associated with the second issue; and
using the obtained information to identify at least one candidate action to address the second issue.

10. The method of claim 1, wherein the generating comprises generating plural candidate actions, the method further comprising:
presenting, for display, the plural candidate actions;
receiving user selection of at least one of the displayed plural candidate actions; and
presenting a potential result for the selected at least one of the plural candidate actions.

11. A system comprising:
a storage media to store information relating to a particular project; and
at least one processor to:
receive information relating to a particular issue of the particular project;
identify plural candidate actions for addressing the particular issue;
generate scores for the plural candidate actions;
present, for display in a user interface, the plural candidate actions and the respective scores; and
receive selection or deselection in the user interface of respective ones of the plural candidate actions.

12. The system of claim 11, wherein the storage media is to further store information relating to past projects, and wherein the at least one processor is to identify the plural candidate actions based on the information relating to selected ones of the past projects.

13. The system of claim 12, wherein the selected past projects include projects identified as similar according to a similarity criterion.

14. The system of claim 12, wherein the plural candidate actions are identified based on information relating to actions taken to address an identified at least one issue of the selected past projects.

15. The system of claim 14, wherein the generated scores are according to one or a combination of: (1) respective impacts of the actions taken in the selected past projects on the at least one issue, (2) relative relevancy of the at least one issue to the particular issue, and (3) relative relevancy of respective ones of the selected past projects to the particular project.

16. The system of claim 11, wherein the plural candidate actions include selection or deselection of respective sub-components of the particular project, and wherein the generated scores are based on effect of selection or deselection of the respective sub-components on the particular issue.

17. An article comprising at least one storage media storing instructions that upon execution cause a system having a processor to:
receive an indication of a particular issue associated with a particular project;
identify, in response to the indication, information relating to the particular issue; and
generate, in response to the identifying, information relating to candidate actions to take to address the particular issue, wherein the candidate actions are identified based on information of selected past projects.

18. The article of claim 17, wherein the selected past projects are similar past projects identified based on a similarity criterion.

19. The article of claim 17, wherein the instructions upon execution cause the system to further:
generate scores for the respective candidate actions, wherein the scores are computed according to information associated with the selected past projects.

20. The article of claim 17, wherein the instructions upon execution cause the system to further:
store information relating to the past projects in a database; and
update the database with information relating to at least one of the candidate actions selected to address the particular issue.
